(19) United States
(12) Patent Application Publication
(10) Pub. No.: US 2023/0169307 A1
(43) Pub. Date: Jun. 1, 2023

(54) METHOD OF EXECUTING CLASS CLASSIFICATION PROCESSING USING MACHINE LEARNING MODEL, INFORMATION PROCESSING DEVICE, AND NON-TRANSITORY COMPUTER-READABLE STORAGE MEDIUM STORING COMPUTER PROGRAM

(71) Applicant: SEIKO EPSON CORPORATION, TOKYO (JP)

(72) Inventors: Tomomasa USUI, Matsumoto-shi (JP); Ryoki WATANABE, Matsumoto-shi (JP); Hikaru KURASAWA, Matsumoto-shi (JP); Shin NISHIMURA, Shiojiri-shi (JP)

(21) Appl. No.: 18/058,862

(22) Filed: Nov. 26, 2022

(30) Foreign Application Priority Data
Nov. 26, 2021 (JP) 2021-192037

(51) Int. Cl. G06N 3/04; G06V 10/774

(52) U.S. Cl. CPC G06N 3/04; G06V 10/774

(57) ABSTRACT

A method according to the present disclosure includes (a) generating N pieces of input data from one target object, (b) inputting the input data to a machine learning model and obtaining M classification output values, one determination class, and a feature spectrum, (c) obtaining a similarity degree between a known feature spectrum group and the feature spectrum for the input data, and obtaining a reliability degree with respect to the determination class as a function of the reliability degree, and (d) executing a vote for the determination class, based on the reliability degree with respect to the determination class, and determining a class determination result of the target object, based on a result of the vote.

The present application is based on, and claims priority from JP Application Serial Number 2021-192037, filed Nov. 26, 2021, the disclosure of which is hereby incorporated by reference herein in its entirety.

### BACKGROUND

### 1. Technical Field

The present disclosure relates to a method of executing class classification processing using a machine learning model, an information processing device, and a non-transitory computer-readable storage medium storing a computer program.

### 2. Related Art

U.S. Pat. No. 5,210,798 and WO 2019/083553 each disclose a so-called capsule network as a machine learning model of a vector neural network type using a vector neuron. The vector neuron indicates a neuron where an input and an output are in a vector expression. The capsule network is a machine learning model where the vector neuron called a capsule is a node of a network. The vector neural network-type machine learning model such as a capsule network is applicable to class classification for input data.

However, in the related art, a class classification result relating to input data, which is to be distinguished as unknown, is erroneously distinguished as a known class in some cases. Thus, it has been desired that accuracy of class classification processing be improved.

### SUMMARY

According to a first aspect of the present disclosure, there is provided a method of executing class classification processing relating to M classes using a machine learning model including a vector neural network including a plurality of vector neuron layers, where M is an integer equal to or greater than 2. The method includes (a) generating N pieces of input data from one target object, where N is an integer equal to or greater than 2, (b) inputting each of the N pieces of input data to the machine learning model, and obtaining, for each of the N pieces of input data, M classification output values that are output from an output layer of the machine learning model, one classified class, and a feature spectrum that is obtained from an output of a specific layer of the machine learning model, (c) obtaining a similarity degree between a known feature spectrum group and the feature spectrum for each of the N pieces of input data, the known feature spectrum group being obtained from the output of the specific layer when a plurality of pieces of teaching data are input to the machine learning model, and obtaining, for each of the N pieces of input data, a reliability degree with respect to the classified class as a function of the similarity degree, and (d) executing, for each of the N pieces of input data, a vote for the classified class, based on the reliability degree with respect to the classified class, and determining a class determination result for the target object, based on a result of the vote.

According to a second aspect of the present disclosure, there is provided an information processing device configured to execute class classification processing relating to M classes using a machine learning model including a vector neural network including a plurality of vector neuron layers, where M is an integer equal to or greater than 2. The information processing device includes a memory configured to store the machine learning model, and a processor configured to execute a calculation using the machine learning model. The processor is configured to execute processing of (a) reading out, from the memory, N pieces of input data generated from one target object, where N is an integer equal to or greater than 2, (b) inputting each of the N pieces of input data to the machine learning model, and obtaining, for each of the N pieces of input data, M classification output values that are output from an output layer of the machine learning model, one classified class, and a feature spectrum that is obtained from an output of a specific layer of the machine learning model, (c) obtaining a similarity degree between a known feature spectrum group and the feature spectrum for each of the N pieces of input data, the known feature spectrum group being obtained from the output of the specific layer when a plurality of pieces of teaching data are input to the machine learning model, and obtaining, for each of the N pieces of input data, a reliability degree with respect to the classified class as a function of the similarity degree, and (d) executing, for each of the N pieces of input data, a vote for the classified class, based on the reliability degree with respect to the classified class, and determining a class determination result for the target object, based on a result of the vote.

According to a third aspect of the present disclosure, there is provided a non-transitory computer-readable storage medium storing a computer program for causing a processor to execute class classification processing relating to M classes using a machine learning model including a vector neural network including a plurality of vector neuron layers, where M is an integer equal to or greater than 2. The computer program causes the processor to execute processing of (a) reading out, from a memory, N pieces of input data generated from one target object, where N is an integer equal to or greater than 2, (b) inputting each of the N pieces of input data to the machine learning model, and obtaining, for each of the N pieces of input data, M classification output values that are output from an output layer of the machine learning model, one classified class, and a feature spectrum that is obtained from an output of a specific layer of the machine learning model, (c) obtaining a similarity degree between a known feature spectrum group and the feature spectrum for each of the N pieces of input data, the known feature spectrum group being obtained from the output of the specific layer when a plurality of pieces of teaching data are input to the machine learning model, and obtaining, for each of the N pieces of input data, a reliability degree with respect to the classified class as a function of the similarity degree, and (d) executing, for each of the N pieces of input data, a vote for the classified class, based on the reliability degree with respect to the classified class, and determining a class determination result for the target object, based on a result of the vote.

### BRIEF DESCRIPTION OF THE DRAWINGS

FIG. 1 is a block diagram illustrating a class classification system in a first exemplary embodiment.

FIG. 2 is an explanatory diagram illustrating a configuration example of a machine learning model.

FIG. 3 is a flowchart illustrating a processing procedure of preparation steps in the exemplary embodiment.

FIG. 4 is an explanatory diagram illustrating a state in which a patch image is generated from a sample image.

FIG. 5 is an explanatory diagram illustrating a feature spectrum.

FIG. 6 is an explanatory diagram illustrating a configuration of a known feature spectrum group.

FIG. 7 is a flowchart illustrating a processing procedure of class classification steps in the first exemplary embodiment.

FIG. 8 is a function block diagram illustrating a class classification processing device in the first exemplary embodiment.

FIG. 9 is an explanatory diagram illustrating the number of votes in the first exemplary embodiment and a comparative example.

FIG. 10 is a function block diagram illustrating a class classification processing device in a second exemplary embodiment.

FIG. 11 is a flowchart illustrating a processing procedure of class classification steps in a third exemplary embodiment.

FIG. 12 is a function block diagram illustrating a class classification processing device in the third exemplary embodiment.

FIG. 13 is an explanatory diagram illustrating a first arithmetic method for obtaining a similarity degree.

FIG. 14 is an explanatory diagram illustrating a second arithmetic method for obtaining a similarity degree.

FIG. 15 is an explanatory diagram illustrating a third arithmetic method and a fourth arithmetic method for obtaining a similarity degree.

### DESCRIPTION OF EXEMPLARY EMBODIMENTS

### A. First Exemplary Embodiment

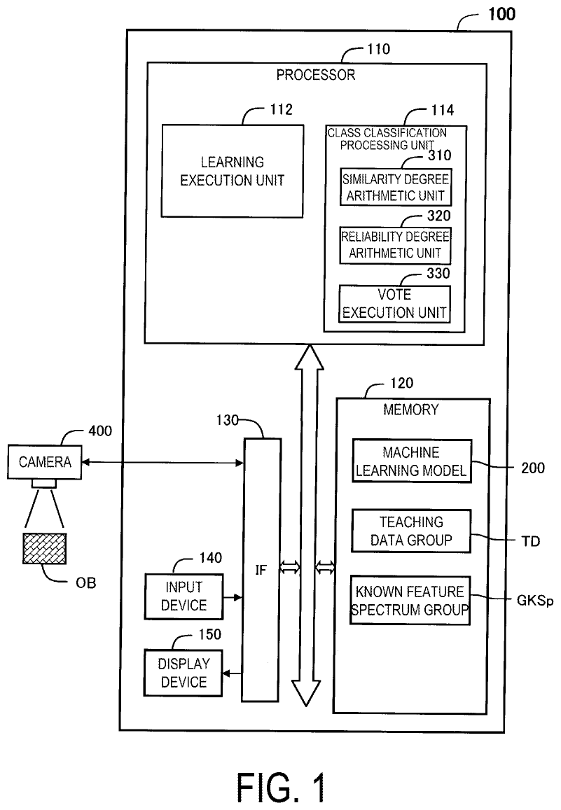

FIG. 1 is a block diagram illustrating a class classification system in a first exemplary embodiment. The class classification system includes an information processing device 100 and a camera 400. The camera 400 captures an image of a target object OB. A camera that captures a color image may be used as the camera 400. Alternatively, a camera that captures a monochrome image or a spectral image may be used. In the present exemplary embodiment, an image captured by the camera 400 is used as teaching data or input data. Alternatively, data other than an image may be used as teaching data or input data. In such a case, an input data reading device selected in accordance with a data type is used in place of the camera 400.

The information processing device 100 includes a processor 110, a memory 120, an interface circuit 130, and an input device 140 and a display device 150 that are coupled to the interface circuit 130. The camera 400 is also coupled to the interface circuit 130. Although not limited thereto, for example, the processor 110 is provided with a function of executing processing, which is described below in detail, as well as a function of displaying, on the display device 150, data obtained through the processing and data generated in the course of the processing.

The processor 110 functions as a learning execution unit 112 that executes learning of a machine learning model and a class classification processing unit 114 that executes class classification processing for input data. The class classification processing unit 114 includes a similarity degree arithmetic unit 310, a reliability degree arithmetic unit 320, and a vote execution unit 330. Each of the learning execution unit 112 and the class classification processing unit 114 are implemented when the processor 110 executes a computer program stored in the memory 120. Alternatively, the learning execution unit 112 and the class classification processing unit 114 may be implemented with a hardware circuit. The processor in the present disclosure is a term including such a hardware circuit. Further, one or a plurality of processors that execute learning processing or class classification processing may be a processor included in one or a plurality of remote computers that are coupled via a network.

In the memory 120, a machine learning model 200, a teaching data group TD, and a known feature spectrum group GKSp are stored. The machine learning model 200 is used for processing executed by the class classification processing unit 114. A configuration example and an operation of the machine learning model 200 are described later. The teaching data group TD is a group of labeled data used for learning of the machine learning model 200. In the present exemplary embodiment, the teaching data group TD is a set of image data. The known feature spectrum group GKSp is a set of feature spectra that are obtained by inputting teaching data again to the machine learning model 200 that is previously learned. The feature spectrum is described later.

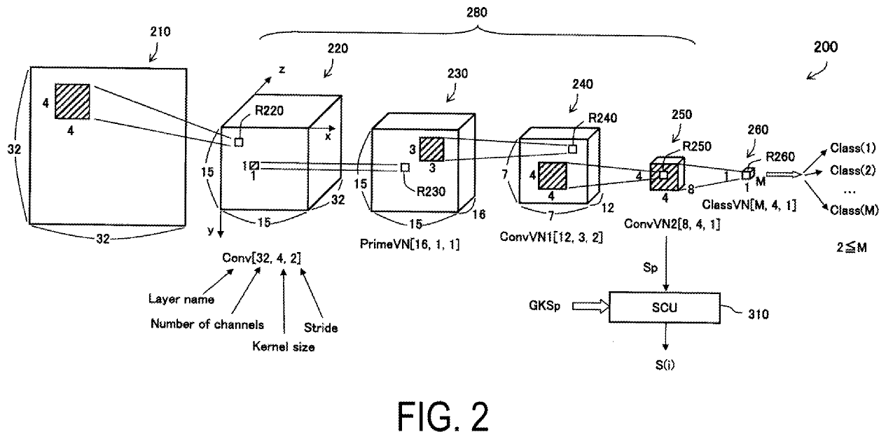

FIG. 2 is an explanatory diagram illustrating a configuration of the machine learning model 200. The machine learning model 200 has an input layer 210, an intermediate layer 280, and an output layer 260. The intermediate layer 280 includes a convolution layer 220, a primary vector neuron layer 230, a first convolution vector neuron layer 240, and a second convolution vector neuron layer 250. The output layer 260 is also referred to as a “classification vector neuron layer 260”. Among those layers, the input layer 210 is the lowermost layer, and the output layer 260 is the uppermost layer. In the following description, the layers in the intermediate layer 280 and the output layer 260 are referred to as the “Conv layer 220”, the “PrimeVN layer 230”, the “ConvVN1 layer 240”, and the “ConvVN2 layer 250”, and “ClassVN layer 260”, respectively.

In the example of FIG. 2, the two convolution vector neuron layers 240 and 250 are used. However, the number of convolution vector neuron layers is freely selected, and the vector neuron layers may be omitted. However, it is preferred that one or more convolution vector neuron layers be used.

An image having a size of 32×32 pixels is input into the input layer 210. A configuration of each of the layers other than the input layer 210 is described as follows.
Conv layer 220: Conv [32, 4, 2]
PrimeVN layer 230: PrimeVN [16, 1, 1]
ConvVN1 layer 240: ConvVN1 [12, 3, 2]
ConvVN2 layer 250: ConvVN2 [8, 4, 1]
ClassVN layer 260: ClassVN [M, 4, 1]
Vector dimension VD: VD=16

In the description for each of the layers, the character string before the brackets indicates a layer name, and the numbers in the brackets indicate the number of channels, a kernel surface size, and a stride in the stated order. For example, the layer name of the Conv layer 220 is “Conv”, the number of channels is 32, the kernel surface size is 4×4, and the stride is two. In FIG. 2, such description is given below each of the layers. A rectangular shape with hatching in each of the layers indicates the kernel surface size that is used for calculating an output vector of an adjacent upper layer. In the present exemplary embodiment, input data is in a form of image data, and hence the kernel surface size is also two-dimensional. Note that the parameter values used in the description of each of the layers are merely examples, and may be changed freely.

Each of the input layer 210 and the Conv layer 220 is a layer configured as a scholar neuron. Each of the other layers 230 to 260 is a layer configured as a vector neuron. The vector neuron is a neuron where an input and an output are in a vector expression. In the description given above, the dimension of an output vector of an individual vector neuron is 16, which is constant. In the description given below, the term “node” is used as a superordinate concept of the scholar neuron and the vector neuron.

In FIG. 2, with regard to the Conv layer 220, a first axis x and a second axis y that define plane coordinates of node arrangement and a third axis z that indicates a depth are illustrated. Further, it is shown that the sizes in the Conv layer 220 in the directions x, y, and z are 15, 15, and 32. The size in the direction x and the size in the direction y indicate the “resolution”. The size in the direction z indicates the number of channels. Those three axes x, y, and z are also used as the coordinate axes expressing a position of each node in the other layers. However, in FIG. 2, illustration of those axes x, y, and z is omitted for the layers other than the Conv layer 220.

As is well known, a resolution W1 after convolution is given with the following equation.

W1=Ceil{(W0−Wk+1)/S} (A1)

Here, W0 is a resolution before convolution, Wk is the kernel surface size, S is the stride, and Ceil{X} is a function of rounding up digits after the decimal point in the value X.

The resolution of each of the layers illustrate in FIG. 2 is an example while assuming that the resolution of the input data is 32, and the actual resolution of each of the layers is changed appropriately in accordance with a size of the input data.

The ClassVN layer 260 has M channels. M is the number of classes that can be distinguished from each other using the machine learning model 200. In the present exemplary embodiment, M is an integer equal to or greater than 2. M classification output values Class (1) to Class (M) are output from M channels of the ClassVN layer 260. A class having the greatest value of the classification output values Class (1) to Class (M) is discriminated as a classified class of the input data. In the present exemplary embodiment, there is no execution of processing of discriminating a class of the input data as unknown by comparing the maximum value of the classification output values Class (1) to Class (M) and a threshold value. Thus, one classified class is always determined for one piece of input data.

In FIG. 2, a partial region Rn is further illustrated in each of the layers 220, 230, 240, 250, and 260. The suffix “n” of the partial region Rn indicates the reference symbol of each of the layers. For example, the partial region R220 indicates the partial region in the Conv layer 220. The “partial region Rn” is a region of each of the layers that is specified with a plane position (x, y) defined by a position in the first axis x and a position in the second axis y and includes a plurality of channels along the third axis z. The partial region Rn has a dimension “Width” x “Height” x “Depth” corresponding to the first axis x, the second axis y, and the third axis z. In the present exemplary embodiment, the number of nodes included in one “partial region Rn” is “1×1× the number of depths”, that is, “1×1× the number of channels”.

As illustrated in FIG. 2, a feature spectrum Sp described later is calculated from an output of the ConvVN2 layer 250, and is input to the similarity degree arithmetic unit 310. The similarity degree arithmetic unit 310 calculates a similarity degree S(i) described above, using the feature spectrum Sp and the known feature spectrum group GKSp that is generated in advance.

In the present disclosure, a vector neuron layer used for calculation of the similarity degree S(i) is also referred to as a “specific layer”. As the specific layer, the vector neuron layers other than the ConvVN2 layer 250 may be used. One or more vector neuron layers may be used, and the number of vector neuron layers is freely selectable. Note that a configuration of the feature spectrum and an arithmetic method of the similarity degree using the feature spectrum are described later.

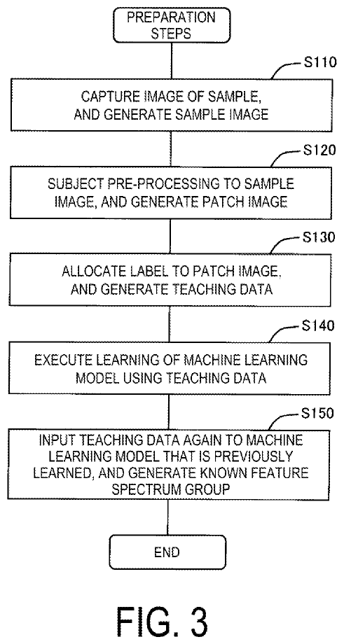

FIG. 3 is a flowchart illustrating a processing procedure of the preparation steps of the machine learning model. In Step S110, the learning execution unit 112 uses the camera 400 to capture images of a plurality of samples. With this, a plurality of sample images are generated. In Step S120, the learning execution unit 112 subjects the sample images to pre-processing, and generates patch images. For example, as the pre-processing, processing such as resolution adjustment and data normalization (min-max normalization) may be used.

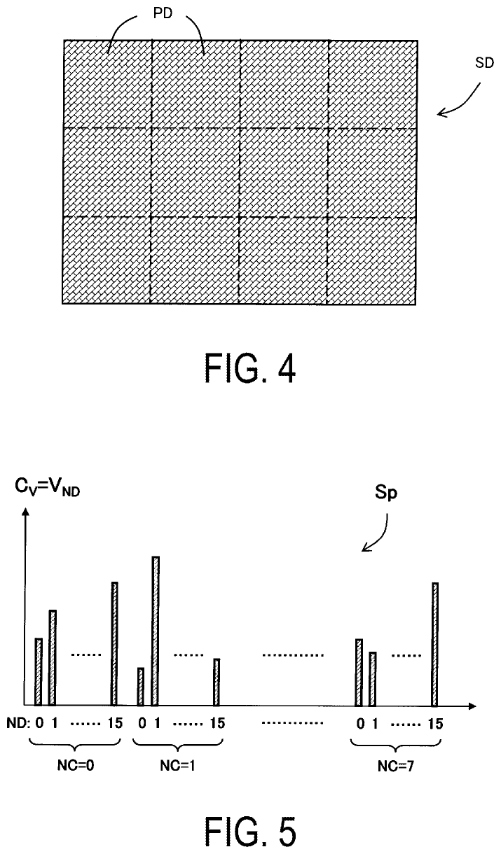

FIG. 4 is an explanatory diagram illustrating a state in which a patch image is generated from a sample image. Here, a plurality of small patch images PD are cut out from a sample image SD. In this example, there is given a case in which the sample image SD is divided into the plurality of patch images PD by the division lines denoted with the broken lines. Each of the patch images PD is used as an image for teaching data. Note that a stride of a segmenting position of the patch image PD may be smaller than a size corresponding to one side of the patch image PD so that the larger number of patch images PD are extracted from one sample image SD. In the present disclosure, the sample image SD is also referred to as “sample data SD”, and the patch image PD is also referred to as “patch data PD”. Note that the sample image SD may directly be used as an image for teaching data without extracting the patch images PD.

In the present exemplary embodiment, the plurality of patch images PD extracted from one sample image SD are used as an image group belonging to one class. The number of known classes is M in the machine learning model 200 illustrated in FIG. 3. Thus, M sample images SD are captured in Step S110, and the plurality of patch images PD are extracted from each of the sample images SD in Step S120.

In Step S130, the learning execution unit 112 allocates a label to the patch image PD, and thus generates the teaching data group TD. In the present exemplary embodiment, M teaching data groups are generated by allocating any one of M labels from 1 to M to each of the patch images PD. Those labels correspond to the M classes of the machine learning model 200 illustrated in FIG. 2. In the present disclosure, the term “label” and the term “class” have the same meaning.

In Step S140, the learning execution unit 112 uses the teaching data group TD, and thus executes learning of the machine learning model 200. After completion of learning, the machine learning model 200 that is previously learned is stored in the memory 120.

In Step S150, the learning execution unit 112 inputs a plurality of pieces of teaching data again to the machine learning model 200 that is previously learned, and generates the known feature spectrum group GKSp. The known feature spectrum group GKSp is a set of feature spectra, which is described later.

FIG. 5 is an explanatory diagram illustrating the feature spectrum Sp obtained by inputting freely-selected input data into the machine learning model 200 that is previously learned. As illustrated in FIG. 2, in the present exemplary embodiment, the feature spectrum Sp is generate from an output of the ConvVN2 layer 250. The horizontal axis in FIG. 5 indicates positions of vector elements relating to output vectors of a plurality of nodes included in one partial region R250 of the ConvVN2 layer 250. Each of the positions of the vector elements is expressed in a combination of an element number ND of the output vector and the channel number NC at each node. In the present exemplary embodiment, the vector dimension is 16 (the number of elements of the output vector being output from each node), and hence the element number ND of the output vector is denoted with 0 to 15, which is sixteen in total. Further, the number of channels of the ConvVN2 layer 250 is eight, and thus the channel number NC is denoted with 0 to 7, which is eight in total. In other words, the feature spectrum Sp is obtained by arranging the plurality of element values of the output vectors of each of the vector neurons included in one partial region R250, over the plurality of channels along the third axis z.

The vertical axis in FIG. 5 indicates a feature value C_{V} at each of the spectrum positions. In this example, the feature value C_{V} is a value V_{ND} of each of the elements of the output vectors. The feature value C_{V} may be subjected to statistic processing such as centering to the average value 0. Note that, as the feature value C_{V}, a value obtained by multiplying the value V_{ND} of each of the elements of the output vectors by a normalization coefficient described later may be used. Alternatively, the normalization coefficient may directly be used. In the latter case, the number of feature values C_{V} included in the feature spectrum Sp is equal to the number of channels, which is eight. Note that the normalization coefficient is a value corresponding to a vector length of the output vector of the node.

The number of feature spectra Sp that can be obtained from an output of the ConvVN2 layer 250 with respect to one piece of input data is equal to the number of plane positions (x, y) of the ConvVN2 layer 250, in other words, the number of partial regions R250, which is sixteen.

The learning execution unit 112 inputs the teaching data again to the machine learning model 200 that is previously learned, calculates the feature spectra Sp illustrated in FIG. 5, and registers the feature spectra Sp as the known feature spectrum group GKSp in the memory 120.

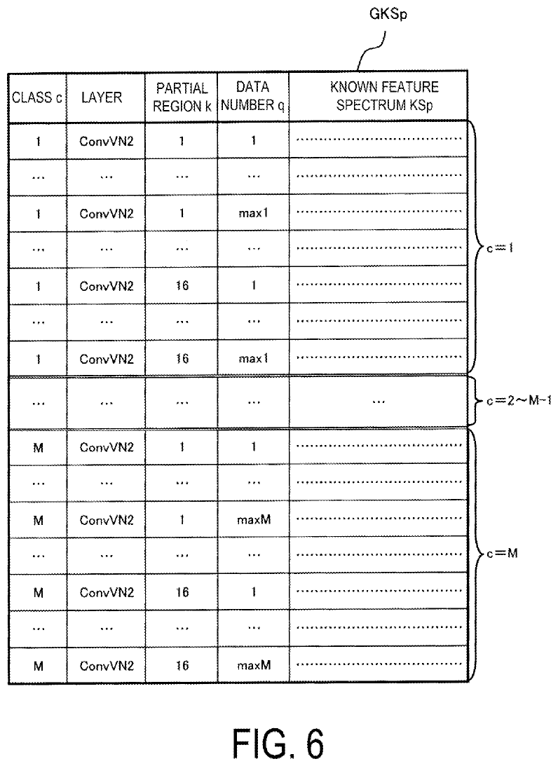

FIG. 6 is an explanatory diagram illustrating a configuration of the known feature spectrum group GKSp. In this example, the known feature spectrum group GKSp obtained from an output of the ConvVN2 layer 250 is illustrated. Note that registration of a known feature spectrum group obtained from an output of at least one vector neuron layer is only required as the known feature spectrum group GKSp. A known feature spectrum group obtained from an output of the ConvVN1 layer 240 or the ClassVN layer 260 may be registered.

Each record in the known feature spectrum group GKSp includes a parameter c indicating a label or a class, a parameter k indicating the order of the partial region Rn in the layer, a parameter q indicating the data number, and a known feature spectrum KSp. The known feature spectrum KSp is the same as the feature spectrum Sp in FIG. 5.

The parameter c indicating a class is a value from 1 to M. The parameter k of the partial region Rn is a value indicating any one of the plurality of partial regions Rn included in the specific layer, in other words, any one of the plane positions (x, y). In a case of the ConvVN2 layer 250, the number of partial regions R250 is sixteen, and hence k=1 to 16. The parameter q of the data number indicates the number of the teaching data denoted with the same label. The parameter q is a value from 1 to max1 in Class 1, and is a value from 1 to maxM in Class M.

The plurality of pieces of teaching data used in Step S150 are not required to be the same as the plurality of pieces of teaching data used in Step S140. However, when part of or an entirety of the plurality of pieces of teaching data used in Step S140 is also used in Step S150, there is no need to prepare new teaching data, which is advantageous.

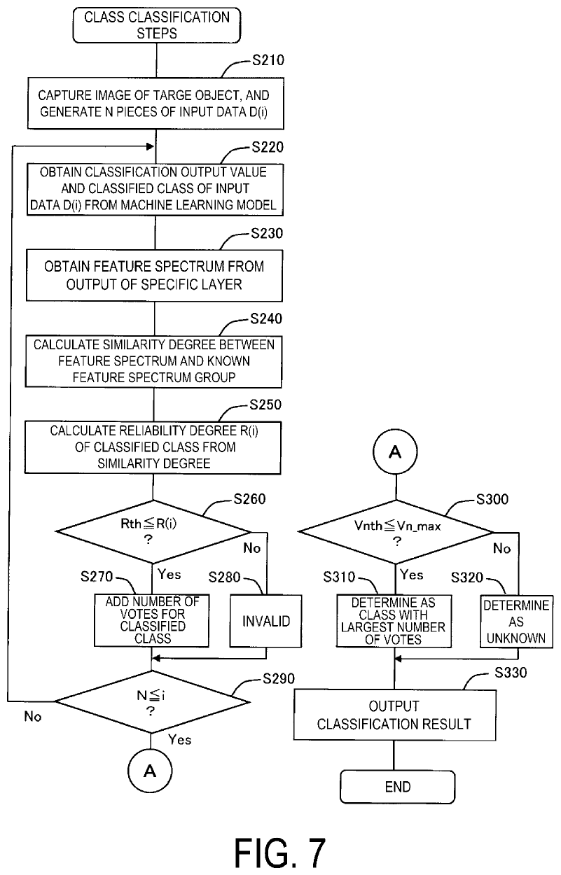

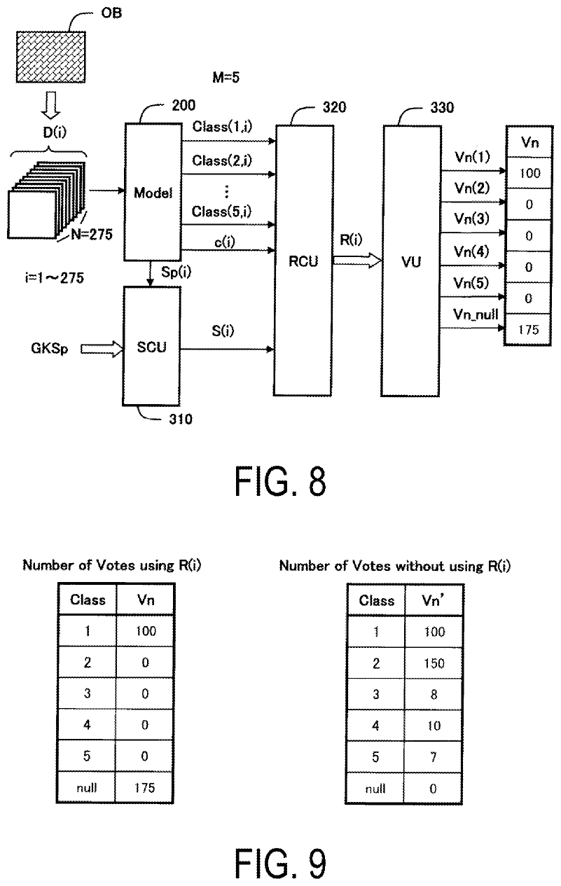

FIG. 7 is a flowchart illustrating a processing procedure of class classification steps using the machine learning model 200 that is previously learned. FIG. 8 is a function block diagram illustrating the class classification processing device in the first exemplary embodiment. FIG. 8 illustrates a case in which the number M of classes is five, and one example of a class classification result is shown on the right end of FIG. 8.

In Step S210, the class classification processing unit 114 uses the camera 400 to capture an image of the target object OB. With this, N pieces of input data D(i) are generated with respect to one target object OB. Here, N is an integer equal to or greater than 2, and i is an integer from 1 to N. In the example of FIG. 8, N=275. As illustrated in FIG. 4, the N pieces of input data D(i) can be obtained by capturing the sample image SD from the target object OB and extracting N patch images PD from the sample image SD. Alternatively, instead of extracting the patch images PD, the N pieces of input data D(i) may be obtained by capturing images of the same target object OB for N times. The class classification processing unit 114 may subject the input data D(i) to the same pre-processing as the pre-processing executed in Step S120 in FIG. 3.

In Step S220, the class classification processing unit 114 inputs one piece of input data D(i) to the machine learning model 200, obtains the M classification output values from the ClassVN layer 260, and determines one classified class. The classified class is a class having the greatest value of the M classification output values. Note that, instead of determining the classified class from the classification output values, a class having the highest similarity degree for each class, which is calculated using the feature spectrum Sp obtained according to the input data D(i), may be determined as the classified class. The arithmetic method for obtaining a similarity degree for each class is described later.

In Step S230, the class classification processing unit 114 uses an output of the ConvVN2 layer 250 being a specific layer, and obtains the feature spectrum Sp illustrated in FIG. 5. FIG. 8 illustrates a case in which the class number M in the machine learning model 200 is five, and illustrates five classification output values Class (1, i) to Class (5, i) that are obtained from the machine learning model 200 with respect to each piece of input data D(i), one classified class c(i), and a feature spectrum Sp(i). In the following description, with regard to the reference symbols in the parentheses of the classification output values Class (1, i) to Class (5, i), the first values “1” to “5” indicate the classes, and the reference symbol “i” indicates the order i of the input data D(i).

As illustrated in FIG. 8, in Step S240, the similarity degree arithmetic unit 310 calculates the similarity degree S(i) between the feature spectrum Sp(i) for the input data D(i) and the known feature spectrum group GKSp illustrated in FIG. 6. The similarity degree S(i) is an index indicating a degree at which the input data D(i) is similar to a feature of the classified class c(i). The arithmetic method for obtaining the similarity degree S(i) is described later.

In Step S250, the reliability degree arithmetic unit 320 calculates a reliability degree R(i) with respect to the classified class c(i), based on the similarity degree S(i). For example, the reliability degree R(i) is calculated with any one of the following equations.

R(i)=S(i) (A2)

R(i)=α×S(i)×Class(c,i) (A3)

R(i)=β×S(i)+(1−β)×Class(c,i) (A4)

where

i is a parameter indicating the order of the input data D(i);

c is a parameter indicating the classified class c(i) of the input data D(i);

S(i) is a similarity degree between the feature spectrum Sp(i) for the input data D(i) and the known feature spectrum group GKSp;

Class (c, i) is a classification output value of the classified class c(i) according to the input data D(i);

α is a positive coefficient other than zero; and

β is a coefficient satisfying 0<β<1.

Equation (A2) given above shows a function in which the similarity degree S(i) itself is regarded as the reliability degree R(i) with respect to the classified class c(i). Equation (A3) given above shows a function for obtaining the reliability degree R(i) by multiplying the similarity degree S(i), the classification output value Class (c, i) with respect to the classified class c(i), and the positive coefficient α other than zero. Equation (A4) given above shows a function for obtaining the reliability degree R(i) by weighted-adding the similarity degree S(i) and the classification output value Class (c, i) with respect to the classified class c(i). When any one of the equations is used, the reliability degree R(i) with respect to the classified class c(i) may be obtained as a function of the similarity degree S(i). The reliability degree R(i) may be calculated from the similarity degree S(i) by using a function other than Equation (A2) to Equation (A4) given above. In this case, it is also preferred to use a function in which the reliability degree R(i) has a positive correlation with the similarity degree S(i).

In Step S260 to Step S280, the vote execution unit 330 compares the reliability degree R(i) of the classified class c(i) with a reliability degree threshold value Rth, and executes a vote, based on a comparison result. Specifically, when Rth R (c, i), one is added to the number of votes of the classified class c(i) in Step S270. In contrast, when R(i)<Rth, the vote of the input data D(i) is invalidated in Step S280. The reliability degree threshold value Rth may be set to 0.995, for example. FIG. 8 illustrates a result obtained by the vote execution unit 330 counting for the number of votes Vn(1) to Vn(5) corresponding to five classes according to the input data D(i). The number of votes Vn_null is the number of pieces of input data D(i) that are invalidated in Step S280.

In Step S290, the class classification processing unit 114 determines whether the processing from Step S220 to S280 is completed for all the input data D(i). When the processing is not completed for all the input data D(i), the procedure returns to Step S220, and the processing from Step S220 to S280 described above is executed for the subsequent input data D(i). When the processing is completed for all the input data D(i), the procedure proceeds to Step S300.

In Step S300 to Step S320, the class classification processing unit 114 compares a maximum number of votes Vn_max in the number of votes Vn corresponding to the M classes with a predetermined vote number threshold value Vnth, and determines a final classification result, based on a comparison result. Specifically, when Vnth≤Vn_max, it is determined that the class of the maximum number of votes Vn_max is a class discrimination result of the target object OB in Step S310. In contrast, when Vn_max<Vnth, it is determined that a class of the target object OB is unknown in Step S320. For example, the vote number threshold value Vnth may be set to 15% to 30% of the total number of votes. In the example in FIG. 8, the vote number threshold value Vnth is set to 50. The maximum number of votes Vn_max is the number of votes Vn(1)=100 for Class 1, and hence the class discrimination result of the target object OB is Class 1. The result shown in FIG. 8 is a result obtained by generating 275 pieces of input data D(i) while using, as the target object OB, the same object as the object used for generating the teaching data for Class 1 and using those pieces of input data D(i). Thus, the result shown in FIG. 8 is a correct class classification result.

FIG. 9 is an explanatory diagram illustrating the number of votes Vn obtained in the first exemplary embodiment, which is shown in FIG. 8, and the number of votes Vn′ in a comparative example, which is obtained without using the reliability degree R(i). The number of votes Vn′ in the comparative example is a result obtained by using the same input data D(i) for the number of votes Vn in the first exemplary embodiment and executing a vote in accordance with the classified class c(i) obtained in Step S220. In a case of the number of votes Vn′ in the comparative example, the number of votes for Class 2 is the largest. Thus, Class 2 is a class classification result of the target object OB, which is erroneous discrimination. Meanwhile, in a case of the number of votes Vn in the exemplary embodiment, Class 1 is a class classification result of the target object OB, which is correct discrimination. As understood from the result in the comparative example, the input data D(i) obtained from the target object OB is data that may lead to erroneous discrimination of a class when class classification is normally executed using the machine learning model 200. Even in this case, the classified class is determined with a vote as in the first exemplary embodiment, and thus a class can be discriminated correctly.

Step S330, the class classification processing unit 114 outputs the classification result to the display device 150. Only the class to which the target object OB belongs may be displayed as a classification result. Alternatively, the number of votes Vn for each class may be displayed as in FIG. 8.

As described above, in the first exemplary embodiment, the reliability degree R(i) with respect to the classified class c(i) is obtained based on the similarity degree S(i) of the feature spectrum Sp, and the class determination result for the target object is determined based on a result of the vote using the reliability degree R(i). Thus, the class classification can be executed at high accuracy. Further, in the first exemplary embodiment, when the reliability degree R(i) is equal to or greater than the reliability degree threshold value Rth, one is added to the number of votes Vn with respect to the classified class c(i). When the reliability degree R(i) is less than the reliability degree threshold value Rth, the vote is invalidated. Thus, the class discrimination result can be determined based on the number of votes Vn according to the reliability degree R(i).

### B. Second Exemplary Embodiment

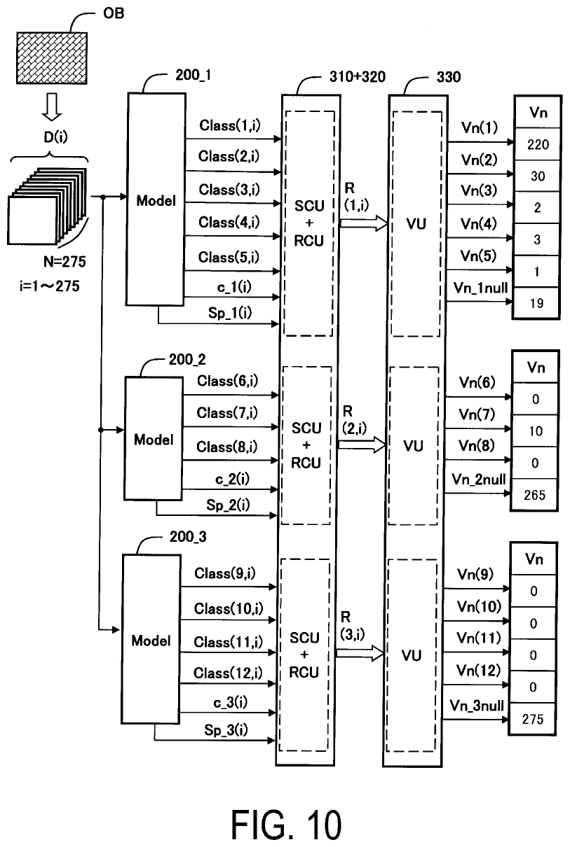

FIG. 10 is a function block diagram illustrating a class classification processing device in a second exemplary embodiment. A device configuration of a class classification system in the second exemplary embodiment is substantially the same as that in FIG. 1. Further, a processing procedure in the second exemplary embodiment is substantially the same as that in FIG. 3 and FIG. 7.

As illustrated in FIG. 10, the class classification system in the second exemplary embodiment includes a plurality of machine learning models 200_1 to 200_3. Each of the machine learning models 200_1 to 200_3 has a configuration similar to that of the machine learning model 200 illustrated in FIG. 2. The additional reference symbols “_1” to “_3” added to the ends of the reference symbols of the machine learning models are provided in order to distinguish the three machine learning models from one another. The numbers of classes of the three machine learning models 200_1 to 200_3 are five, three, and four, respectively, and the total number of classes is twelve. The three machine learning models 200_1 to 200_3 has substantially the same function as that in a case in which the number M of classes in one machine learning model 200 in the first exemplary embodiment, which is illustrated in FIG. 2, is twelve. However, as the number of classes of one machine learning model 200 is increased, a longer time period is required for learning. Thus, when a plurality of machine learning models are used, classification processing can be executed at a high speed. Further, when the number of distinguishable classes is large, degradation of classification accuracy can be prevented. Further, when the learning data is replaced, and re-learning of the machine learning model is executed, an entirety thereof is not required to be subjected to re-learning. Thus, learning can advantageously be executed at a high speed.

The input data D(i) is input to each of the three machine learning models 200_1 to 200_3. From the first machine learning model 200_1, the classification output values Class (1, i) to Class (5, i) relating to the five classes are output according to the input data D(i). Further, a feature spectrum Sp_1(i) is calculated. Further, one classified class c_1(i) is determined from the maximum value of the classification output values Class (1, i) to Class (5, i). For convenience of illustration, FIG. 10 collectively illustrates the similarity degree arithmetic unit 310 and the reliability degree arithmetic unit 320 as one block. The broken-line blocks illustrated in the block of the similarity degree arithmetic unit 310 and the reliability degree arithmetic unit 320 indicate that outputs of the three machine learning models 200_1 to 200_3 are independently processed.

From the second machine learning model 200_2, classification output values Class (6, i) to Class (8, i) relating to the three classes and a classified class c_2(i) are output according to the input data D(i). Further, a feature spectrum Sp_2(i) is calculated. From the third machine learning model 200_3, classification output values Class (9, i) to Class (12, i) relating to the four classes and a classified class c_3(i) are output according to the input data D(i). Further, the feature spectrum Sp_3(i) is calculated.

The similarity degree arithmetic unit 310 and the reliability degree arithmetic unit 320 use the classification output values Class (1, i) to Class (5, i) and the feature spectrum Sp_1(i) that are obtained from the first machine learning model 200_1, and calculate a reliability degree R(c_1, i) with respect to the classified class c_1 (i). The calculation method for obtaining reliability degree R(c_1, i) is similar to that in the first exemplary embodiment. A reliability degree R(c_2, i) with respect to the classified class c_2(i) and a reliability degree R(c_3, i) with respect to the classified class c_3(i) are similarly calculated from the other machine learning models 200_2 and 200_3.

The vote execution unit 330 executes votes according to the reliability degrees R(1, i), R(2, i), and R(3, i) that are obtained from the three machine learning models 200_1 to 200_3, respectively. As a result, the numbers of votes Vn(1) to Vn(12) for twelve classes are obtained as illustrated in the right end of FIG. 10. Note that the number of votes Vn_1null is the number of pieces of input data D(i) for which a vote is invalidated in the first machine learning model 200_1. Similarly, the numbers of votes Vn_2null and Vn_3null are the numbers of pieces of input data D(i) for which votes are invalidated in the machine learning model 200_2 and the machine learning model 200_3. From the numbers of votes Vn(1) to Vn(12) in FIG. 10, a class classification result of the target object OB is correctly determined as Class 1.

Note that the vote may be executed only in the machine learning model with greatest reliability degree in the reliability degrees R(1, i), R(2, i), and R(3, i). In this case, with regard to the number of votes in the right-end row in FIG. 10, the total number of votes for all the machine learning models is 275. With this, the class of the target object OB can also be determined correctly from the numbers of votes Vn(1) to Vn(12).

The second exemplary embodiment described above can also have effects similar to those in the first exemplary embodiment, and enables highly accurate class classification. Further, the second exemplary embodiment uses a plurality of machine learning models. Thus, classification processing can be executed at a high speed even when the number M of distinguishable classes is large, and degradation of classification accuracy can be prevented.

### C. Third Exemplary Embodiment

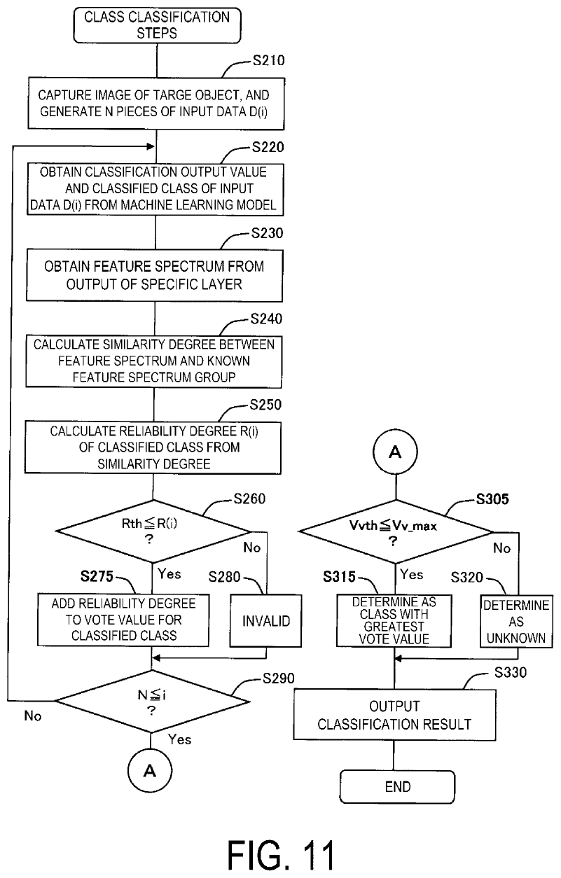

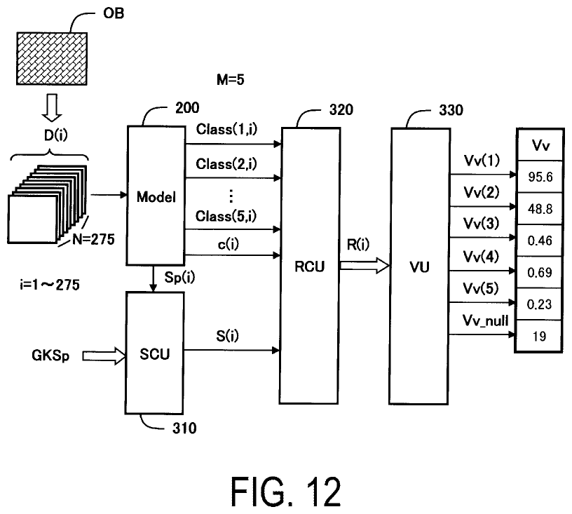

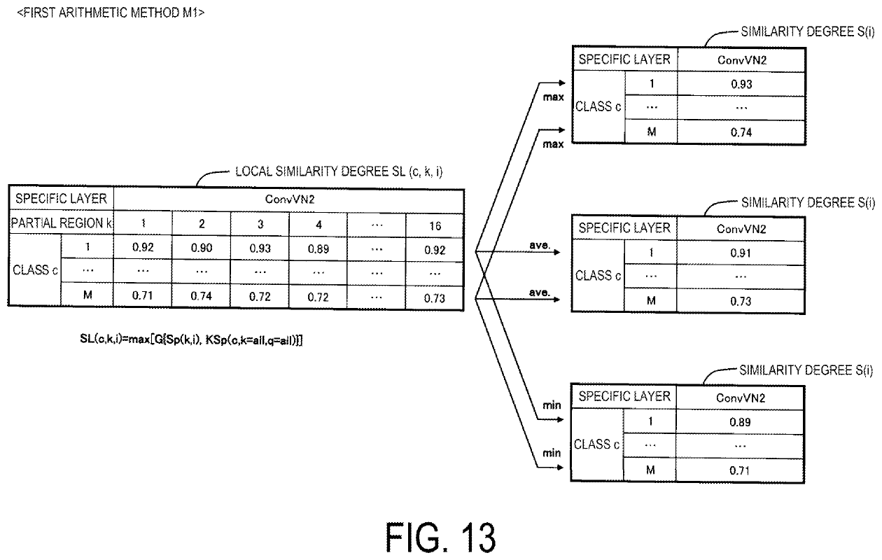

FIG. 11 is a flowchart illustrating a processing procedure of class classification steps in a third exemplary embodiment. FIG. 12 is a function block diagram illustrating the class classification processing device in the third exemplary embodiment. A device configuration of a class classification system in the third exemplary embodiment is substantially the same as that in FIG. 1. The third exemplary embodiment is different from the first exemplary embodiment and the second exemplary embodiment described above in that a vote value is added for each class instead of the number of votes and a class classification result is determined based on a result of the addition.

The processing procedure in the third exemplary embodiment, which is illustrated in FIG. 11, is obtained by replacing Step S270, Step S300, and Step S310 in the processing procedure in the first exemplary embodiment, which is illustrated in FIG. 7, with Step S275, Step S305, and Step S315. The other steps thereof are the same as those in FIG. 7.

When the reliability degree R(i) of the classified class c(i) is equal to or greater than the reliability degree threshold value Rth in Step S260, the reliability degree R(i) is added to a vote value Vv of the classified class c(i) in Step S275. In the first exemplary embodiment illustrated in FIG. 8, one is added to the number of votes Vn. In contrast, in the third exemplary embodiment illustrated in FIG. 12, the reliability degree R(i) is added to the vote value Vv. FIG. 12 illustrates a state in which the vote execution unit 330 calculates vote values Vv(1) to Vv(5) for five classes according to the input data D(i).

When adding of the vote value Vv is performed, the reliability degree threshold value Rth may be set to a minimum value that the reliability degree R(i) may be. For example, when the value of the reliability degree (c, i) may fall within a range from −1.0 to +1.0, the reliability degree threshold value Rth may be set to the minimum value thereof, that is, −1.0. When the reliability degree threshold value Rth is set to the minimum value, all the determination results in Step S260 are Yes. Thus, the procedure always proceeds to Step S275. Then, the reliability degree R(i) is added to the vote value Vv of the classified class c(i). The processing in this case is substantially equivalent to processing without Step S260 and Step S280. In other words, “processing of adding the reliability degree R(i) as the vote value Vv with respect to the classified class c(i) when the reliability degree R(i) is equal to or greater than the reliability degree threshold value Rth” widely involves “processing of adding the reliability degree R(i) as the vote value Vv with respect to the classified class c(i) without using the reliability degree threshold value Rth”. However, when the reliability degree threshold value Rth is set to a value greater than the minimum value that the reliability degree R(i) may be, a vote of the classified class c(i) with a lower reliability degree R(i) can be invalidated. Thus, a desirable value as the vote value Vv can be obtained.

In Step S305, the class classification processing unit 114 compares a maximum vote value Vv_max in the vote values Vv relating to the M classes with a predetermined vote value threshold value Vvth, and determines a final classification result, based on a comparison result. Specifically, when Vvth<Vv_max, it is determined that the class of the maximum vote value Vv_max is a class discrimination result of the target object OB in Step S315. In contrast, when Vv_max<Vvth, it is determined that a class of the target object OB is unknown in Step S320. For example, the vote value threshold value Vvth may be set to 15% to 30% of the total number of votes. In the example in FIG. 12, the vote value threshold value Vvth is set to 50, and the class discrimination result of the target object OB is Class 1.

Similarly to the first exemplary embodiment, in the third exemplary embodiment, the reliability degree R(i) with respect to the classified class c(i) is also obtained based on the similarity degree S(i) of the feature spectrum Sp, and the class determination result for the target object is also determined based on a result of the vote using the reliability degree R(i). Thus, the class classification can be executed at high accuracy. Further, in the third exemplary embodiment, when the reliability degree R(i) is equal to or greater than the reliability degree threshold value Rth, the reliability degree R(i) is added to the vote value Vv with respect to the classified class c(i). When the reliability degree R(i) is less than the reliability degree threshold value Rth, the vote is invalidated. Thus, the class discrimination result can be determined based on the vote value Vv according to the reliability degree R(i).

### D. Method of Calculating Similarity Degree

For example, any one of the following methods may be employed as the arithmetic method of the similarity degree S(i) described above.

(1) A first arithmetic method M1 for obtaining the similarity degree S(i) for each class without considering correspondence of a partial region Rn in the feature spectrum Sp and the known feature spectrum group GKSp

(2) A second arithmetic method M2 for obtaining the similarity degree S(i) for each class in the partial regions Rn corresponding to the feature spectrum Sp and the known feature spectrum group GKSp

(3) A third arithmetic method M3 for obtaining a similarity degree S(i) for each class without considering the partial region Rn at all

(4) A fourth arithmetic method M4 for obtaining the similarity degrees S(i) of the feature spectrum Sp and the known feature spectrum group GKSp without making discriminations between classes

In the following description, description is sequentially made on methods of calculating the similarity degree S(i) from an output of the ConvVN2 layer 250 while following those arithmetic methods M1 to M4.

FIG. 13 is an explanatory diagram illustrating the first arithmetic method M1 for obtaining the similarity degree S(i). In the first arithmetic method M1, first, a local similarity degree SL(c, k, i) indicating a similarity degree with respect to the classified class c(i) for each of the partial regions k is calculated from an output of the ConvVn2 layer 250 being the specific layer, in accordance an equation described below. In the machine learning model 200 in FIG. 2, the number of partial regions R250 of the ConvVN2 layer 250 is sixteen, and hence the parameter k indicating the partial region is 1 to 16. Any one of three types of similarity degrees S(i) for each class, which are illustrated on the right side of FIG. 13, is calculated from the local similarity degree SL(c, k, i).

In the first arithmetic method M1, the local similarity degree SL(c, k, i) is calculated using the following equation.

SL(c,k,i)=max[G{Sp(k,i),KSp(c,k=all,q=all)}] (D1),

where

c is a parameter indicating the classified class c(i);

k is a parameter indicating the order of the partial region Rn;

i is a parameter indicating the order of the input data D(i);

q is a parameter indicating the data number;

G{a, b} is a function for obtaining a similarity degree between a and b;

Sp(k, i) is a feature spectrum obtained from an output of the specified partial region k of the specific layer according to the input data D(i);

KSp(c, k=all, q=all) are known feature spectra of all the data numbers q of all the partial regions k of the specific layer, which are associated with Class c, in the known feature spectrum group GKSp illustrated in FIG. 6; and

max [X] is a logic operation for obtaining the maximum value of the values X.

Note that, as the function G{a, b} for obtaining the similarity degree, for example, an equation for obtaining a cosine similarity degree or a similarity degree corresponding to a distance may be used.

The three types of the similarity degrees S(i), which are illustrated on the right side of FIG. 13, are obtained by obtaining a maximum value, an average value, or a minimum value of the local similarity degree SL(c, k, i) of the plurality of partial regions k. A calculation to be used for obtaining the maximum value, the average value, or the minimum value is set in accordance with a purpose of use of the class classification processing. A calculation selected from these three types is set in advance through experimental or empirical observation of a user.

As described above, in the first arithmetic method M1 for obtaining the similarity degree S(i),

(1) the local similarity degree SL(c, k, i) being a similarity degree between the feature spectrum Sp (k, i) and all the feature spectra Sp(k, c, q) is obtained, the feature spectrum Sp (k, i) being obtained from an output of the specified partial region k of the specific layer, according to the input data D(i), all the known feature spectra KSp being associated with the specific layer and Class c, and

(2) the similarity degree S(i) is obtained by obtaining the maximum value, the average value, or the minimum value of the local similarity degree SL(c, k, i) for the plurality of partial regions k.

With the first arithmetic method M1, the similarity degree S(i) for each class can be obtained in a calculation and a procedure that are relatively simple.

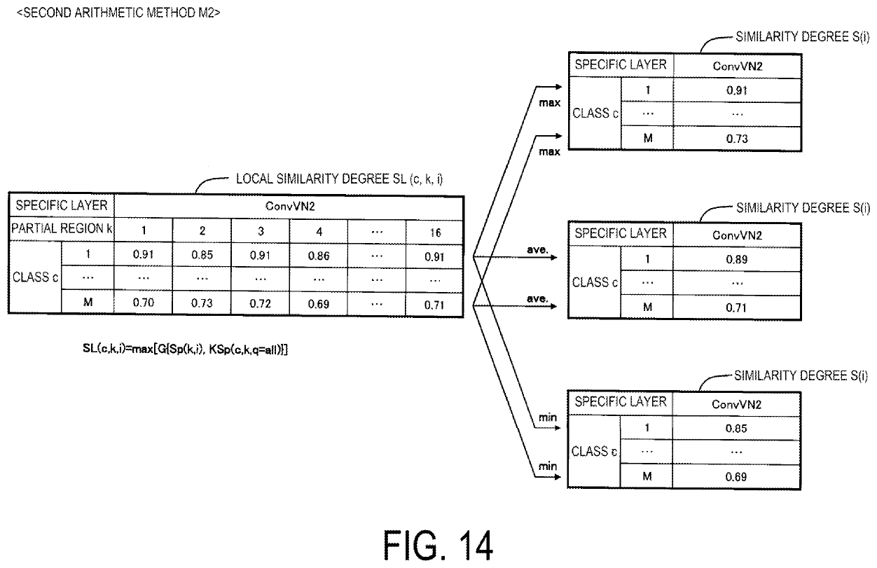

FIG. 14 is an explanatory diagram illustrating the second arithmetic method M2 for obtaining the similarity degree S(i). In the second arithmetic method M2, the local similarity degree SL(c, k, i) is calculated using the following equation in place of Equation (D1) given above.

SL(c,k,i)=max[G{Sp(k,i),KSp(c,k,q=all)}] (D2), where

KSp(c, k, q=all) are known feature spectra of all the data numbers q of the specified partial region k of the specific layer, which are associated with Class c, in the known feature spectrum group GKSp illustrated in FIG. 6.

In the first arithmetic method M1 described above, the known feature spectra KSp(c, k=all, q=all) in all the partial regions k of the specific layer are used. In contrast, the second arithmetic method M2 only uses the known feature spectra KSp(c, k, q=all) of the same partial region k of the partial region k of the feature spectrum Sp (k, i). Other contents of the second arithmetic method M2 are similar to those of the first arithmetic method M1.

In the second arithmetic method M2 for obtaining the similarity degree S(i),

(1) the local similarity degree SL(c, k, i) being a similarity degree between the feature spectrum Sp (k, i) and all the feature spectra Sp(k, c, q) is obtained, the feature spectrum Sp (k, i) being obtained from an output of the specified partial region k of the specific layer, according to the input data D(i), all the known feature spectra KSp being associated with the specified partial region k of the specific layer and Class c, and

(2) the similarity degree S(i) is obtained by obtaining the maximum value, the average value, or the minimum value of the local similarity degree SL(c, k, i) for the plurality of partial regions k.

With the second arithmetic method M2, the similarity degree S(i) for each class can also be obtained in a calculation and a procedure that are relatively simple.

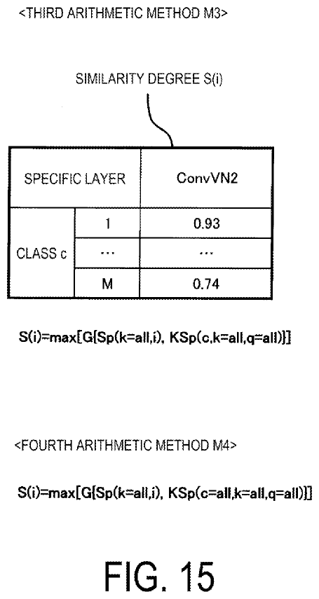

FIG. 15 is an explanatory diagram illustrating the third arithmetic method M3 and the fourth arithmetic method M4 for obtaining the similarity degree S(i). In the third arithmetic method M3, the similarity degree S(i) is calculated from an output of the ConvVN2 layer 250 being the specific layer, without obtaining the local similarity degree SL(c, k, i).

The similarity degree S(i) obtained in the third arithmetic method M3 is calculated using the following equation. S(i)=max[G{Sp(k=all, i), KSp(c, k=all, q=all)}](D3), where

Sp(k=all, i) are feature spectra obtained from outputs of all the partial regions k of the specific layer, according to the input data D(i).

As described above, in the third arithmetic method M3 for obtaining the similarity degree S(i),

(1) the similarity degree S(i) being a similarity degree between all the feature spectra Sp and all the known feature spectra KSp is obtained, all the feature spectra Sp being obtained from an output of the specific layer according to the input data D(i), all the known feature spectra KSp being associated with the specific layer and Class c.

With the third arithmetic method M3, the similarity degree S(i) for each class can be obtained in a calculation and a procedure that are further simple.

Each of the three arithmetic methods M1 to M3 described above is an arithmetic method for obtaining the similarity degree S(i) for each class. A similarity degree with one classified class c(i) among the similarity degrees S(i) of the respective classes is used as the similarity degree S(i) described in the exemplary embodiments given above. Note that the similarity degree S(i) is calculated for each class with respect to the M classes, and the class with the maximum value may be determined as the classified class c(i). In this case, instead of determining the classified class c(i) from the classification output values in Step S220 in FIG. 7 and FIG. 11, processing of determining one classified class c(i) from the similarity degrees S(i) of the respective classes with respect to the M classes is executed after Step S240.

In the fourth arithmetic method M4, the similarity degree S(i) between the feature spectrum Sp and the known feature spectrum KSp is calculated without discriminating the classes from one another. The similarity degree S(i) obtained in the fourth arithmetic method M4 is calculated using the following equation similar to Equation (D3) given above.

S(i)=max[G{Sp(k=all,i),KSp(c=all,k=all,q=all)}] (D4), where

Sp(k=all, i) are feature spectra obtained from outputs of all the partial regions k of the specific layer, according to the input data D(i); and

KSp (c=all, k=all, q=all) are known feature spectra of all the data numbers q of all the partial regions k of the specific layer, which are associated with all Classes c, in the known feature spectrum group GKSp illustrated in FIG. 6.

The fourth arithmetic method M4 does not consider a class of the known feature spectrum KSp. However, in general, the similarity degree S(i) obtained from Equation (D4) given above matches with the similarity degree S(i) obtained from Equation (D3) given above with respect to the classified class c(i) determined from the classification output values Class (1, i) to Class (M, i) of the machine learning model 200. Thus, with the fourth arithmetic method M4, the similarity degree S(i) with respect to the classified class c(i) can substantially be obtained.

Each of the four arithmetic methods M1 to M4 described above is a method for executing a calculation for the similarity degree S(i) using an output of one specific layer. However, a calculation for the similarity degree S(i) can be executed while one or more of the plurality of vector neuron layers 240, 250, and 260 illustrated in FIG. 2 is regarded as the specific layer. For example, when the plurality of specific layers are used, it is preferred that the minimum value of the plurality of similarity degrees S(i) obtained from the plurality of specific layers be used as the final similarity degree S(i).

### E. Arithmetic Method of Output Vector in Each Layer of Machine Learning Model

Arithmetic methods for obtaining an output of each of the layers illustrated in FIG. 2 are as follows.

For each of the nodes of the PrimeVN layer 230, a vector output of the node is obtained by regarding scholar outputs of 1×1×32 nodes of the Conv layer 220 as 32-dimensional vectors and multiplying the vectors by a transformation matrix. In the transformation matrix, a surface size is a 1×1 kernel element. The transformation matrix is updated by learning of the machine learning model 200. Note that processing in the Conv layer 220 and processing in the PrimeVN layer 230 may be integrated so as to configure one primary vector neuron layer.

When the PrimeVN layer 230 is referred to as a “lower layer L”, and the ConvVN1 layer 240 that is adjacent on the upper side is referred to as an “upper layer L+1”, an output of each node of the upper layer L+1 is determined using the following equations.

$$\begin{matrix}[ Mathematical Expression 1 ] & \\ & \end{matrix}$$

$$\begin{matrix}[ Math . 1 ] & \\ {v}_{ij} = {W}_{ij}^{L} {M}_{i}^{L} & ( E 1 )\end{matrix}$$

$${u}_{j} = {\sum }_{i} {v}_{ij} \qquad ( E 2 )$$

$${a}_{j} = F ( ‖ {u}_{j} ‖ ) \qquad ( E 3 )$$

$${M}_{j}^{L + 1} = {a}_{j} \times \frac{1}{‖ {u}_{j} ‖} {u}_{j} \qquad ( E 4 )$$

where

M^{L}ᵢ is an output vector of an i-th node in the lower layer L;

M^{L+1}_{J} is an output vector of a j-th node in the upper layer L+1;

vᵢⱼ is a predicted vector of the output vector M^{L+1}ⱼ;

W^{L}ᵢⱼ is a predicted matrix for calculating the predicted vector vᵢⱼ from the output vector M^{L}ᵢ of the lower layer L;

uⱼ is a sum vector being a sum of the predicted vector vᵢⱼ, that is, a linear combination;

aⱼ is an activation value being a normalization coefficient obtained by normalizing a norm |uⱼ| of the sum vector uⱼ; and

F(X) is a normalization function for normalizing X.

For example, as the normalization function F(X), Equation (E3a) or Equation (E3b) given below may be used. [Mathematical Expression 2]

$$\begin{matrix}[ Math . 2 ] & \\ {a}_{j} = F ( ‖ {u}_{j} ‖ ) = softmax ( ‖ {u}_{j} ‖ ) = \frac{exp ( β ‖ {u}_{j} ‖ )}{{\sum }_{k} exp ( β ‖ {u}_{k} ‖ )} & ( E 3 a )\end{matrix}$$

$${a}_{j} = F ( ‖ {u}_{j} ‖ ) = \frac{‖ {u}_{j} ‖}{{\sum }_{k} ‖ {u}_{k} ‖} \qquad ( E 3 b )$$

where

k is an ordinal number for all the nodes in the upper layer L+1; and

β is an adjustment parameter being a freely-selected positive coefficient, for example, β=1.

In Equation (E3a) given above, the activation value aⱼ is obtained by normalizing the norm |uⱼ| of the sum vector uⱼ with the softmax function for all the nodes in the upper layer L+1. Meanwhile, in Equation (E3b), the norm |uⱼ| of the sum vector uⱼ is divided by the sum of the norm |uⱼ| of all the nodes in the upper layer L+1. With this, the activation value aⱼ is obtained. Note that, as the normalization function F(X), a function other than Equation (E3a) and Equation (E3b) may be used.

For sake of convenience, the ordinal number i in Equation (E2) given above is allocated to each of the nodes in the lower layer L for determining the output vector M^{L+1}ⱼ of the j-th node in the upper layer L+1, and is a value from 1 to n. Further, the integer n is the number of nodes in the lower layer L for determining the output vector M^{L+1}ⱼ of the j-th node in the upper layer L+1. Therefore, the integer n is provided in the equation given below.

n=Nk×Nc (E5)

Here, Nk is a kernel surface size, and Nc is the number of channels of the PrimeVN layer 230 being a lower layer. In the example of FIG. 2, Nk=9 and Nc=16. Thus, n=144.

One kernel used for obtaining an output vector of the ConvVN1 layer 240 has 144 (3×3×16) elements, each of which has a surface size being a kernel size of 3×3, and has a depth being the number of channels in the lower layer of 16. Each of the elements is a prediction matrix W^{L}ᵢⱼ. Further, in order to generate output vectors of 12 channels of the ConvVN1 layer 240, 12 kernel pairs are required. Therefore, the number of predication matrices W_{L}^{ij} of the kernels used for obtaining output vectors of the ConvVN1 layer 240 is 1,728 (144×12). Those prediction matrices W^{L}ᵢⱼ are updated by learning of the machine learning model 200.

As understood from Equation (E1) to Equation (E4) given above, the output vector M^{L+1}ⱼ of each of the nodes in the upper layer L+1 is obtained by the following calculation.

(A) the predicted vector vᵢⱼ is obtained by multiplying the output vector M^{L}ᵢ of each of the nodes in the lower layer L by the prediction matrix W^{L}ᵢⱼ;

(b) the sum vector uⱼ being a sum of the predicted vectors vᵢⱼ of the respective nodes in the lower layer L, which is a linear combination, is obtained;

(c) the activation value aⱼ being a normalization coefficient is obtained by normalizing the norm |uⱼ| of the sum vector uⱼ; and

(d) the sum vector uⱼ is divided by the norm |uⱼ|, and is further multiplied by the activation value aⱼ.

Note that the activation value aⱼ is a normalization coefficient that is obtained by normalizing the norm |uⱼ| for all the nodes in the upper layer L+1. Therefore, the activation value aⱼ can be considered as an index indicating a relative output intensity of each of the nodes among all the nodes in the upper layer L+1. The norm used in Equation (E3), Equation (E3a), Equation (E3b), and Equation (4) is an L2 norm indicating a vector length in a general example. In this case, the activation value aⱼ corresponds to a vector length of the output vector M^{L+1}ⱼ. The activation value aⱼ is only used in Equation (E3) and Equation (E4) given above, and hence is not required to be output from the node. However, the upper layer L+1 may be configured so that the activation value aⱼ is output to the outside.

A configuration of the vector neural network is substantially the same as a configuration of the capsule network, and the vector neuron in the vector neural network corresponds to the capsule in the capsule network. However, the calculation with Equation (E1) to Equation (E4) given above, which are used in the vector neural network, is different from a calculation used in the capsule network. The most significant difference between the two calculations is that, in the capsule network, the predicted vector vᵢⱼ in the right side of Equation (E2) given above is multiplied by a weight and the weight is searched by repeating dynamic routing for a plurality of times. Meanwhile, in the vector neural network of the present exemplary embodiment, the output vector M^{L+1}ⱼ is obtained by calculating Equation (E1) to Equation (E4) given above once in a sequential manner. Thus, there is no need of repeating dynamic routing, and the calculation can be executed faster, which are advantageous points. Further, the vector neural network of the present exemplary embodiment has a less memory amount, which is required for the calculation, than the capsule network. According to an experiment conducted by the inventor of the present disclosure, the vector neural network requires approximately ⅓ to ½ of the memory amount of the capsule network, which is also an advantageous point.

The vector neural network is similar to the capsule network in that a node with an input and an output in a vector expression is used. Therefore, the vector neural network is also similar to the capsule network in that the vector neuron is used. Further, in the plurality of layers 220 to 260, the upper layers indicate a feature of a larger region, and the lower layers indicate a feature of a smaller region, which is similar to the general convolution neural network. Here, the “feature” indicates a feature included in input data to the neural network. In the vector neural network or the capsule network, an output vector of a certain node contains space information indicating information relating to a spatial feature expressed by the node. In this regard, the vector neural network or the capsule network are superior to the general convolution neural network. In other words, a vector length of an output vector of the certain node indicates an existence probability of a feature expressed by the node, and the vector direction indicates space information such as a feature direction and a scale. Therefore, vector directions of output vectors of two nodes belonging to the same layer indicate positional relationships of the respective features. Alternatively, it can also be said that vector directions of output vectors of the two nodes indicate feature variations. For example, when the node corresponds to a feature of an “eye”, a direction of the output vector may express variations such as smallness of an eye and an almond-shaped eye. It is said that, in the general convolution neural network, space information relating to a feature is lost due to pooling processing. As a result, as compared to the general convolution neural network, the vector neural network and the capsule network are excellent in a function of distinguishing input data.

The advantageous points of the vector neural network can be considered as follows. In other words, the vector neural network has an advantageous point in that an output vector of the node expresses features of the input data as coordinates in a successive space. Therefore, the output vectors can be evaluated in such a manner that similar vector directions show similar features. Further, even when features contained in input data are not covered in teaching data, the features can be interpolated and can be distinguished from each other, which is also an advantageous point. In contrast, in the general convolution neural network, disorderly compaction is caused due to pooling processing, and hence features in input data cannot be expressed as coordinates in a successive space, which is a drawback.

An output of each of the node in the ConvVN2 layer 250 and the ClassVN layer 260 are similarly determined through use Equation (E1) to Equation (E4) given above, and detailed description thereof is omitted. A resolution of the ClassVN layer 260 being the uppermost layer is 1×1, and the number of channels thereof is M.

An output of the ClassVN layer 260 is converted into the plurality of classification output values Class (1) to Class (M) for the plurality of classes. In general, those classification output values are values obtained through normalization with the softmax function. Specifically, for example, a vector length of an output vector is calculated from the output vector of each of the nodes in the ClassVN layer 260, and the vector length of each of the nodes is further normalized with the softmax function. By executing this calculation, a classification output value for each of the classes can be obtained. As described above, the activation value aⱼ obtained by Equation (E3) given above is a value corresponding to a vector length of the output vector M^{L+1}ⱼ, and is normalized. Therefore, the activation value aⱼ of each of the nodes in the ClassVN layer 260 may be output, and may be used directly as a classification output value of each of the classes.

In the exemplary embodiment described above, as the machine learning model 200, the vector neural network that obtains an output vector by a calculation with Equation (E1) to Equation (E4) given above is used. Instead, the capsule network disclosed in each of U.S. Pat. No. 5,210,798 and WO 2019/083553 may be used.

### OTHER ASPECTS

The present disclosure is not limited to the exemplary embodiment described above, and may be implemented in various aspects without departing from the spirits of the disclosure. For example, the present disclosure can also be achieved in the following aspects. Appropriate replacements or combinations may be made to the technical features in the above-described exemplary embodiment which correspond to the technical features in the aspects described below to solve some or all of the problems of the disclosure or to achieve some or all of the advantageous effects of the disclosure. Additionally, when the technical features are not described herein as essential technical features, such technical features may be deleted appropriately.

<1> According to a first aspect of the present disclosure, there is provided a method of executing class classification processing relating to M classes using a machine learning model including a vector neural network including a plurality of vector neuron layers, where M is an integer equal to or greater than 2. The method includes (a) generating N pieces of input data from one target object, where N is an integer equal to or greater than 2, (b) inputting each of the N pieces of input data to the machine learning model, and obtaining, for each of the N pieces of input data, M classification output values that are output from an output layer of the machine learning model, one classified class, and a feature spectrum that is obtained from an output of a specific layer of the machine learning model, (c) obtaining a similarity degree between a known feature spectrum group and the feature spectrum for each of the N pieces of input data, the known feature spectrum group being obtained from the output of the specific layer when a plurality of pieces of teaching data are input to the machine learning model, and obtaining, for each of the N pieces of input data, a reliability degree with respect to the classified class as a function of the similarity degree, and (d) executing, for each of the N pieces of input data, a vote for the classified class, based on the reliability degree with respect to the classified class, and determining a class determination result for the target object, based on a result of the vote.

With this method, the reliability degree with respect to the classified class is obtained based on the similarity degree of the feature spectrum, and the class determination result for the target object is determined based on a result of the vote using the reliability degree. Thus, the class classification can be executed at high accuracy.

<2> In the method described above, (c) may include any one of (1) regarding the similarity degree as the reliability degree, (2) obtaining the reliability degree by multiplying the similarity degree, the classification output value with respect to the classified class, and a positive coefficient other than zero, and (3) obtaining the reliability degree by weighted addition of the similarity degree and the classification output value with respect to the classified class.

With this method, the reliability degree of the classified class can be obtained as a function of the similarity degree.

<3> In the method described above, (d) may include (d1) adding one to the number of votes for the classified class when the reliability degree is equal to or greater than a reliability degree threshold value, and invalidating a vote when the reliability degree is less than the reliability degree threshold value, for each of the N pieces of input data, and (d2) determining, as the class determination result, a class among the M classes, the class having the largest number of votes for the N pieces of input data.

With this method, the class determination result can be determined based on the number of votes according to the reliability degree.

<4> In the method described above, (d2) may include determining that a class of the target object is unknown when the largest number of votes is less than a vote number threshold value.

With this method, a case in which a class of the target object is unknown can be determined correctly.

<5> In the method described above, (d) may include (d1) adding the reliability degree as a vote value for the classified class when the reliability degree is equal to or greater than a reliability degree threshold value, for each of the N pieces of input data, and (d2) invalidating the vote when the reliability degree is less than the reliability degree threshold value, and determining, the class determination result, a class among the M classes, the class having the greatest vote value for the N pieces of input data.

With this method, the class determination result can be determined based on the vote value according to the reliability degree.

<6> In the method described above, (d2) may include determining that a class of the target object is unknown when the greatest vote value is less than a vote value threshold value.

With this method, a case in which a class of the target object is unknown can be determined correctly.

<7> In the method described above, the specific layer may have a configuration in which a vector neuron arranged in a plane defined with two axes including a first axis and a second axis is arranged as a plurality of channels along a third axis being a direction different from the two axes. The feature spectrum may be any one of (i) a first type of a feature spectrum obtained by arranging a plurality of element values of an output vector of a vector neuron at one plane position in the specific layer, over the plurality of channels along the third axis, (ii) a second type of a feature spectrum obtained by multiplying each of the plurality of element values of the first type of the feature spectrum by an activation value corresponding to a vector length of the output vector, and (iii) a third type of a feature spectrum obtained by arranging the activation value at one plane position in the specific layer, over the plurality of channels along the third axis.

With this method, the feature spectrum can easily be obtained.

<8> According to a second aspect of the present disclosure, there is provided an information processing device configured to execute class classification processing relating to M classes using a machine learning model including a vector neural network including a plurality of vector neuron layers, where M is an integer equal to or greater than 2. The information processing device includes a memory configured to store the machine learning model, and a processor configured to execute a calculation using the machine learning model. The processor is configured to execute processing of (a) reading out, from the memory, N pieces of input data generated from one target object, where N is an integer equal to or greater than 2, (b) inputting each of the N pieces of input data to the machine learning model, and obtaining, for each of the N pieces of input data, M classification output values that are output from an output layer of the machine learning model, one classified class, and a feature spectrum that is obtained from an output of a specific layer of the machine learning model, (c) obtaining a similarity degree between a known feature spectrum group and the feature spectrum for each of the N pieces of input data, the known feature spectrum group being obtained from the output of the specific layer when a plurality of pieces of teaching data are input to the machine learning model, and obtaining, for each of the N pieces of input data, a reliability degree with respect to the classified class as a function of the similarity degree, and (d) executing, for each of the N pieces of input data, a vote for the classified class, based on the reliability degree with respect to the classified class, and determining a class determination result for the target object, based on a result of the vote.

<9> According to a third aspect of the present disclosure, there is provided a non-transitory computer-readable storage medium storing a computer program for causing a processor to execute class classification processing relating to M classes using a machine learning model including a vector neural network including a plurality of vector neuron layers, where M is an integer equal to or greater than 2. The computer program causes the processor to execute processing of (a) reading out, from a memory, N pieces of input data generated from one target object, where N is an integer equal to or greater than 2, (b) inputting each of the N pieces of input data to the machine learning model, and obtaining, for each of the N pieces of input data, M classification output values that are output from an output layer of the machine learning model, one classified class, and a feature spectrum that is obtained from an output of a specific layer of the machine learning model, (c) obtaining a similarity degree between a known feature spectrum group and the feature spectrum for each of the N pieces of input data, the known feature spectrum group being obtained from the output of the specific layer when a plurality of pieces of teaching data are input to the machine learning model, and obtaining, for each of the N pieces of input data, a reliability degree with respect to the classified class as a function of the similarity degree, and (d) executing, for each of the N pieces of input data, a vote for the classified class, based on the reliability degree with respect to the classified class, and determining a class determination result for the target object, based on a result of the vote.

The present disclosure may be achieved in various forms other than the above-mentioned aspects. For example, the present disclosure can be implemented in forms including a computer program for achieving the functions of the class classification device, and a non-transitory storage medium storing the computer program.

What is claimed is:

1. A method of executing class classification processing relating to M classes using a machine learning model including a vector neural network including a plurality of vector neuron layers, where M is an integer equal to or greater than 2, the method comprising:
(a) generating N pieces of input data from one target object, where N is an integer equal to or greater than 2;
(b) inputting each of the N pieces of input data to the machine learning model, and obtaining, for each of the N pieces of input data, M classification output values that are output from an output layer of the machine learning model, one classified class, and a feature spectrum that is obtained from an output of a specific layer of the machine learning model;
(c) obtaining a similarity degree between a known feature spectrum group and the feature spectrum for each of the N pieces of input data, the known feature spectrum group being obtained from the output of the specific layer when a plurality of pieces of teaching data are input to the machine learning model, and obtaining, for each of the N pieces of input data, a reliability degree with respect to the classified class as a function of the similarity degree; and
(d) executing, for each of the N pieces of input data, a vote for the classified class, based on the reliability degree with respect to the classified class, and determining a class determination result for the target object, based on a result of the vote.

2. The method according to claim 1, wherein
(c) includes any one of:
(1) regarding the similarity degree as the reliability degree;
(2) obtaining the reliability degree by multiplying the similarity degree, the classification output value with respect to the classified class, and a positive coefficient other than zero; and
(3) obtaining the reliability degree by weighted addition of the similarity degree and the classification output value with respect to the classified class.

3. The method according to claim 1, wherein
(d) includes:
(d1) adding one to the number of votes for the classified class when the reliability degree is equal to or greater than a reliability degree threshold value, and invalidating a vote when the reliability degree is less than the reliability degree threshold value, for each of the N pieces of input data; and
(d2) determining, as the class determination result, a class among the M classes, the class having the largest number of votes for the N pieces of input data.

4. The method according to claim 3, wherein
(d2) includes determining that a class of the target object is unknown when the largest number of votes is less than a vote number threshold value.

5. The method according to claim 1, wherein
(d) includes:
(d1) adding the reliability degree as a vote value for the classified class when the reliability degree is equal to or greater than a reliability degree threshold value, for each of the N pieces of input data; and
(d2) invalidating the vote when the reliability degree is less than the reliability degree threshold value, and determining, as the class determination result, a class among the M classes, the class having the greatest vote value for the N pieces of input data.

6. The method according to claim 5, wherein
(d2) includes determining that a class of the target object is unknown when the greatest vote value is less than a vote value threshold value.

7. The method according to claim 1, wherein
the specific layer has a configuration in which a vector neuron arranged in a plane defined with two axes including a first axis and a second axis is arranged as a plurality of channels along a third axis being a direction different from the two axes, and
the feature spectrum is any one of:
(i) a first type of a feature spectrum obtained by arranging a plurality of element values of an output vector of a vector neuron at one plane position in the specific layer, over the plurality of channels along the third axis;
(ii) a second type of a feature spectrum obtained by multiplying each of the plurality of element values of the first type of the feature spectrum by an activation value corresponding to a vector length of the output vector; and
(iii) a third type of a feature spectrum obtained by arranging the activation value at one plane position in the specific layer, over the plurality of channels along the third axis.

8. An information processing device configured to execute class classification processing relating to M classes using a machine learning model including a vector neural network including a plurality of vector neuron layers, where M is an integer equal to or greater than 2, the information processing device comprising:
a memory configured to store the machine learning model; and
a processor configured to execute a calculation using the machine learning model, wherein
the processor is configured to execute processing of:
(a) reading out, from the memory, N pieces of input data generated from one target object, where N is an integer equal to or greater than 2;
(b) inputting each of the N pieces of input data to the machine learning model, and obtaining, for each of the N pieces of input data, M classification output values that are output from an output layer of the machine learning model, one classified class, and a feature spectrum that is obtained from an output of a specific layer of the machine learning model;
(c) obtaining a similarity degree between a known feature spectrum group and the feature spectrum for each of the N pieces of input data, the known feature spectrum group being obtained from the output of the specific layer when a plurality of pieces of teaching data are input to the machine learning model, and obtaining, for each of the N pieces of input data, a reliability degree with respect to the classified class as a function of the similarity degree; and
(d) executing, for each of the N pieces of input data, a vote for the classified class, based on the reliability degree with respect to the classified class, and determining a class determination result for the target object, based on a result of the vote.

9. A non-transitory computer-readable storage medium storing a computer program for causing a processor to execute class classification processing relating to M classes using a machine learning model including a vector neural network including a plurality of vector neuron layers, where M is an integer equal to or greater than 2, the computer program for causing the processor to execute processing of:
(a) reading out, from a memory, N pieces of input data generated from one target object, where N is an integer equal to or greater than 2;
(b) inputting each of the N pieces of input data to the machine learning model, and obtaining, for each of the N pieces of input data, M classification output values that are output from an output layer of the machine learning model, one classified class, and a feature spectrum that is obtained from an output of a specific layer of the machine learning model;
(c) obtaining a similarity degree between a known feature spectrum group and the feature spectrum for each of the N pieces of input data, the known feature spectrum group being obtained from the output of the specific layer when a plurality of pieces of teaching data are input to the machine learning model, and obtaining, for each of the N pieces of input data, a reliability degree with respect to the classified class as a function of the similarity degree; and
(d) executing, for each of the N pieces of input data, a vote for the classified class, based on the reliability degree with respect to the classified class, and determining a class determination result for the target object, based on a result of the vote.
